(19) United States
(12) Patent Application Publication
(10) Pub. No.: US 2006/0255513 A1
(43) Pub. Date: Nov. 16, 2006

(54) Mold gap seal

(75) Inventor: Kent Goss, Louisburg, KS (US)

Correspondence Address: VENABLE LLP, P.O. BOX 34385, WASHINGTON, DC, 20043-9998, US

(73) Assignee: GRAHAM PACKAGING COMPANY, L.P., York, PA (US)

(21) Appl. No.: 11/126,312

(22) Filed: May 11, 2005

(51) Int. Cl. B29C 49/00

(52) U.S. Cl. 264/523; 425/525

(57) ABSTRACT

A container is disclosed. The container may be a hot-fill container having an improved geometry. The container may comprise a base, a body portion attached to the base and a concave waist attached to the body portion and having a surface. The surface including a plurality of axial apexes and troughs alternately arranged around the waist. A dome may be attached to the waist. A finish may be attached to the dome, the finish having an opening.

### BACKGROUND OF THE INVENTION

1. Field of the Invention

The present invention relates generally to a method and apparatus for blow-molding containers, and more particularly to an improved mold.

2. Related Art

Blow-molded plastic containers are commonplace in packaging beverages and other liquid, gel, or granular products. A large number of beverages, as well as a variety of food products, are packaged in plastic containers and/or containers. Plastic has proven to be readily adapted to being formed into a variety of shapes and sizes, and a variety of plastics can be used to form containers to package beverages, for example, non-carbonated, carbonated, refrigerated or pasteurized beverages, as well as containers for semi-solid food products, to include mayonnaise and peanut butter.

The plastics used to form these containers may include high density polyethylene (“HDPE”) used primarily for forming milk containers and for industrial applications, for example forming drums, flasks, and toys; polyvinylchloride (“PVC”), the pioneer polymer used in packaging non-carbonated or slightly carbonated beverages; and polyethylene terephthalate (“PET”), which is a lightweight transparent plastic material having superior resistance to impact, heat, and pressure, and which is 100% recyclable. PET is among the most commonly used plastics for packaging non-carbonated and carbonated liquids, to include water, fruit juices, soft drinks, cooking oil, household cleaning products, as well as liquids which may have required pasteurization or hot filling.

Biaxially oriented containers which are manufactured for use as containers for pressurized liquid are conventionally made using a blow molding process. In one type of blow molding process the preform is blown into conformance with a chilled mold. But in order to increase the dimensional stability of biaxially oriented containers to make them useful for “hot fill” operations, it is necessary to thermo-fix or “heat set” the biaxially oriented container in such a way that substantially relieves the remaining internal stresses.

A typical type of blow molding machine utilized to manufacture blow molded containers is a wheel blow molding machine which is vertically disposed and rotates about a horizontal axis. An example of such a machine is illustrated in FIG. 1 of U.S. Pat. No. 5,681,597 issued to Aguilar et al. and by the discussion provided in the Aguilar patent on column 2, line 52 to column 3, line 23. To this end, the blow molding machine has a plurality of molds positioned in a circular array following a circular path of motion. Each mold has a pair of mold halves which open to receive a parison or perform which can be formed by ejection molding. The mold halves then close so that the parison can be blown into conformance with the cavity defined by the mold. After the preforms are heated to the desired temperature, usually near the glass transition temperature (Tg) of the particular plastic from which the preform is molded, the preform is transferred into a blow-mold cavity. While in the blow-mold cavity, the preform is blown by means of compressed air into the shape of the mold cavity while preferably simultaneously being subjected to axial stretching to effect biaxial orientation of the container, all known in the art. The mold halves then open to release the blown article. All of these operations occur as the wheel continuously rotates at a constant speed, thereby forming and releasing blown articles in a continuous manner.

As the air is blown into the preform, the air between the cavity wall and the preform must be vented as the preform expands. If additional air is introduced into this area at a volume and supply that cannot be handled by the venting process, problems with the container may result. Interference with the venting process causes lack of container detail and definition and the overall heat set capabilities of the mold may be compromised. One source of additional air that may interfere with the venting process is air introduced by the blow nozzle via the gap between the mold halves and into the mold cavity. Existing blow molding apparatuses lack a proper seal at the parting line between the blow mold halves below the blow nozzle. Air may enter the mold via this opening. It is thought that the cooling effect resulting from the rapid traveling of air over the mold surfaces may contribute to ovality of the container in the area under the support flange. As containers are often conveyed or located by this area for labeling and capping, the ovality results in overall production line inefficiency.

The overall blow mold quality of a well-designed heat set blow molded container may be determined by a combination of factors directed to the economics of the process (impacted by the speed of blowing) and the surface temperature of the hot blow mold (limited by the amount of cooling gas which can be blown through the container). There is therefore a need to reduce or eliminate the amount of air introduced into the mold cavity via the mold gap.

### SUMMARY OF THE INVENTION

In an exemplary embodiment of the present invention, a blow molding apparatus is disclosed. The apparatus comprises a plurality of mold shells disposed adjacent to each other and having interior surfaces that define a mold cavity and a gap between adjacent ones of the mold shells. A barrier is arranged in the gap to at least partially block air from flowing via the gap into the mold cavity.

In another embodiment of the invention, the blow mold comprises a first mold shell having an interior surface defining a partial mold cavity and a border surface on the interior surface outside of the cavity. A second mold shell has an interior surface defining a partial mold cavity and a border surface on the interior surface outside of the cavity. The first and second mold shells form a mold cavity when their respective partial mold cavities and border surfaces are arranged opposite and interface with each other. A gap is arranged at the interface between the border surfaces of first and second mold shells. A barrier is formed in the gap to form a seal at least partially preventing air flow through the gap into the mold cavity.

In another embodiment of the invention, a mold is provided. The mold comprises two mold halves defining a mold cavity therein. The mold has a first end with an opening formed by the mold halves communicating with the mold cavity and adapted to receive a perform. A parting line is arranged between the mold halves at the first end, with a seal arranged in the parting line.

In another embodiment of the invention, a method of molding a container is provided. The method comprises bringing a plurality of mold shells together to define a cavity corresponding to the container therein; inserting a preform into the cavity; blowing air into the preform in order to expand the preform within the cavity; and substantially preventing the blow air from entering the cavity via a gap between the mold shells.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 depicts an a cross section of an exemplary embodiment of a mold apparatus according to the present invention;

FIG. 2 depicts a cross section of an exemplary embodiment of a mold apparatus according to the present invention;

FIG. 3 is a cross-section of an exemplary embodiment of the mold shell of present invention;

FIG. 4 is an isometric view of an exemplary embodiment of a blow molding apparatus of the present invention; and

FIG. 5 is an isometric view of an exemplary embodiment of a blow molding apparatus of the present invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

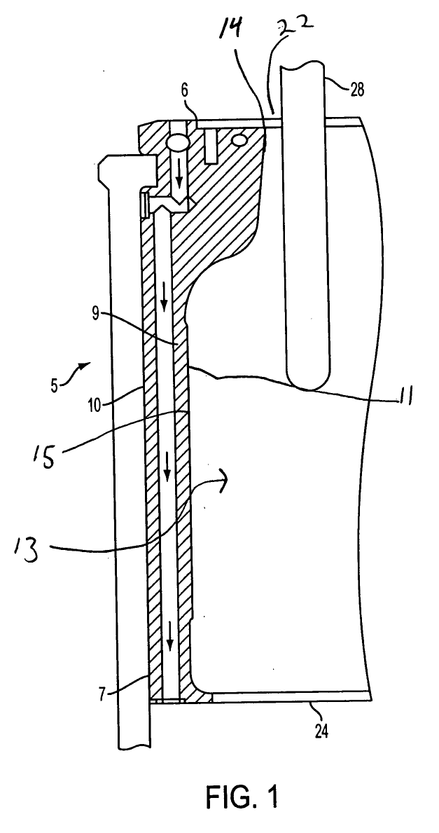

Referring now to the drawings, in FIG. 1 a mold for blow molding is shown. The mold may be formed from a number of different portions. For example, a pair of substantially identical elongate blow mold shells. The mold halves in the disclosed embodiment are substantially identical to one another, and may be completely identical if so desired. Each blow mold shell 5 has a first end 6 and a spaced second end 7. Extending between the two ends of the blow mold shell is an elongate sidewall 9 having an outwardly facing exterior surface 10 and an interior surface 11. Each of the mold halves define a cavity therein. The cavity is used for molding an article, which here comprises a container. Each blow mold shell 5 is fashioned by being machined from a ductile metal, preferably stainless steel, although other types of steel or metals suited for use as blow mold shells may suffice.

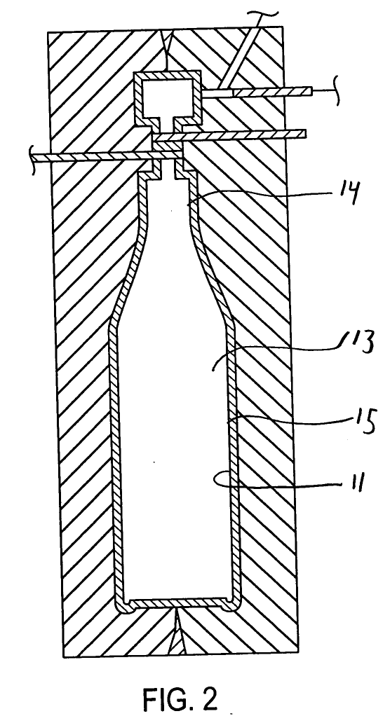

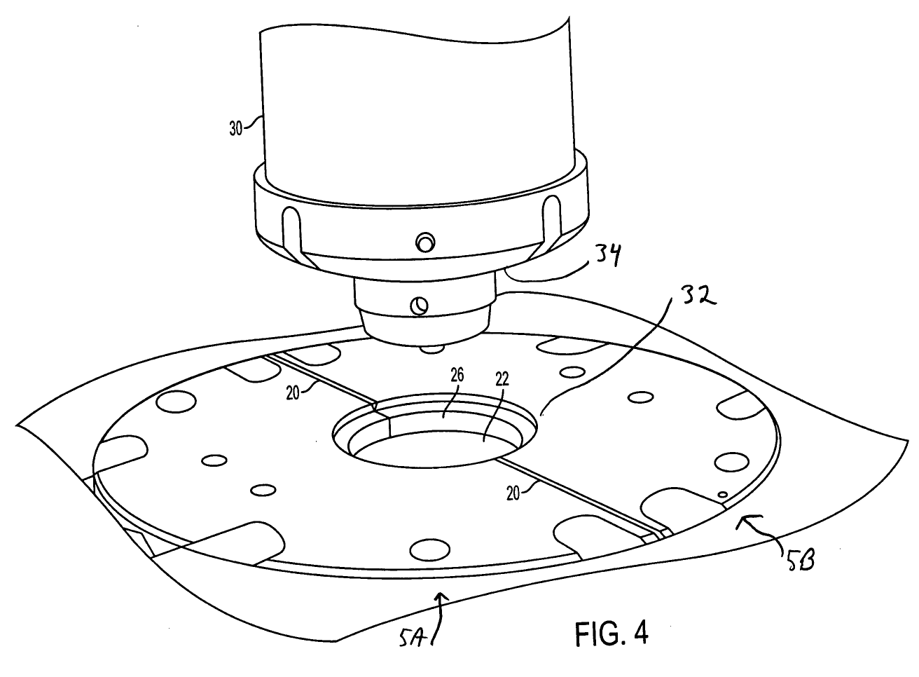

As best shown in FIGS. 1-3, a partial molding cavity 13 is defined within the interior surface 11 of the blow mold shell. In known fashion, the partial molding cavity defines a container neck forming portion 14 approximate the first end 6 of the blow mold shell, and a container body forming portion 15 extending between the container neck forming portion and the second end 7 of the blow mold shell. The first and second ends 6, 7 of the molds shells form openings 22, 24 that communicate with the cavity. The mold shells 5 may be provided with curved surfaces 26 or recesses that define openings 22, 24. The mold shells 5 may be moved between an open position and a closed position. When the mold shells are in the closed position (see FIG. 4), a mold parting gap 20 is formed between the mold shells 5. The mold parting gap 20 may extend from an outer surface 10 of the shells 5, between the shells 5 to the cavity. The mold parting gap 20 may be a result of the imperfect fit between the mold shells 5.

Numeral 28 generally indicates a parison or preform which is substantially test tube shaped. The elongated tubular preforms 28 have a closed end and an opened end around which is generally formed a thread. The preforms are loaded onto a suitable blow nozzle for conveying the preforms into the mold via the opening 22 at the first end 6 of the mold for a blow molding operation. The present invention is described with reference to stretch blow molding. However, molds having a barrier according to the present invention can be used in other blow molding operations, for example, any of extrusion blow molding, and injection blow molding, which are well known to those of skill in the art. During the blow molding process, the mold shells are typically heated in order to heat set the container.

The blow nozzle 30 with the preform 28 mounted thereon is lowered towards the closed mold shells. The preform 28 is inserted into the mold via the opening 22 at the first end 6 of the mold. The blow nozzle 30 is lowered until the blow nozzle 30 contacts a striking plate 32 on top of the mold shells (FIG. 4). The blow nozzle 30 is usually provided with a seal 34 that extends in a circular fashion around the blow nozzle. The seal 34 is pressed between the blow nozzle 30 and the striking plate 32, around the opening 22.

The preform 28 is expanded within the mold to form the desired container by the introduction of a blowing gas into the preform 28 through its open end. Thus, the preform 28 is stretched and continues to expand within the mold until the walls of the container conform to the shape of the mold cavity. When the blown container achieves contact with the surface 11 of the cavity within the mold, the container is maintained in contact with the mold cavity surface 11 by continued application of the blowing gas pressure for a time sufficient to cool the inner surface of the container sufficiently to maintain the shape of the container when the blowing pressure is stopped and the blow mold opens. The mold shells are moved to the open position to remove the molded article.

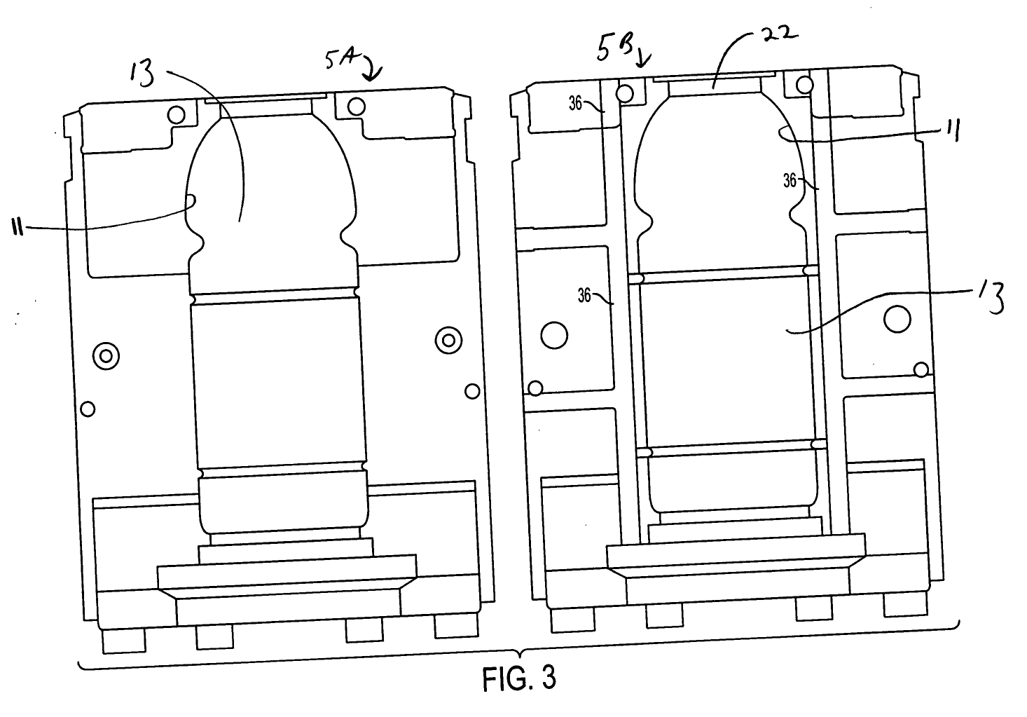

The mold shells may also include vents 36 as shown in FIG. 3. The vents 36 may be provided in order to provide an exhaust path for air within the cavity. As the preform 28 inside the mold expands, air between the preform and the wall 11 of the cavity must be evacuated from the cavity. The vents 36 should be arranged to allow air to be exhausted from within the cavity to the exterior of the mold. The vents 36 are typically sized to handle the volume of air that is present in the cavity. However, if additional air is introduced into the cavity during the blow molding process, the vents 36 may not be able to accommodate it.

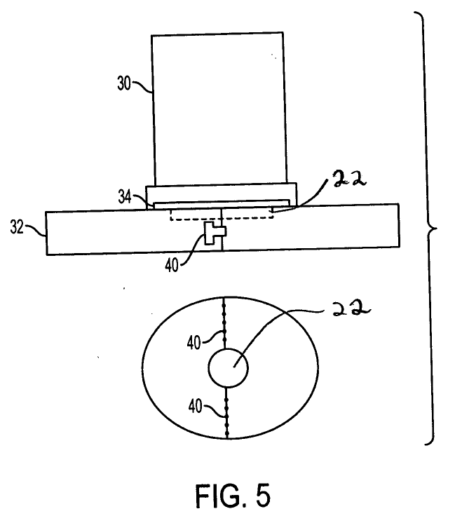

One such source of additional air may be air from the blow nozzle 30 that enters the cavity through the mold parting gap 20 during the blow molding process. If blow air from the blow nozzle 30 is allowed to enter the cavity, the blow air is of a volume and supply that can not be handled by the cavity vents 36. In order to prevent or minimize this or other air from being introduced into the cavity via the mold parting gap 20, a barrier, such as seal 40, for the mold parting gap 20 may be provided as shown in FIG. 5. Preferably the barrier is arranged near the top of the mold, where the blow air enters the mold cavity. The barrier may be arranged at the first end 6 of the mold and extend between the mold shells 5 on either side of the opening 22. The seal 40 may be pliable, gasket type material that compresses upon closing of the blow mold. The seal 40 may be rubber, urethane, or other heat resistant pliable material. The seal 40 or other barrier should be able to withstand the compression and heat that is present during the blow molding process.

In a further embodiment of the invention, as shown in FIG. 5, at least one of the mold shells 5 may be provided with a seal 40. The seal 40 should be sized to compress upon closing of the mold to form a seal between the mold shells. The seal 40 may be provided on mold shell in any fashion. When the mold shells are closed, the seal 40 on mold shell 5A is compressed by mold shell 5B to close or seal the mold parting gap 20. Additionally, a groove (not shown) may be provided in mold shell 5B to receive the seal and form a tighter seal between the mold shells. Thus, when the mold shells 5A, 5B are closed, the seal 40 prevents or reduces the amount of blow air that is introduced into the cavity. The seal 40 may be any type of barrier that at least partially blocks the mold parting gap 20.

Accordingly, embodiments of the present invention provide an improved blow mold apparatus and method. For example, the barrier may prevent or substantially reduce the blow air from entering the cavity at the mold parting gap, increasing overall container definition, detail and heat set qualities.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A blow molding apparatus, comprising:
a plurality of mold shells having first and second ends, disposed adjacent to each other and having interior surfaces that define a mold cavity having an opening for receiving a perform at the first end and a gap between adjacent ones of the mold shells; and
a barrier arranged in the gap adjacent to the first end to at least partially block air from flowing via the gap into the mold cavity.

2. The apparatus of claim 1, wherein the barrier is a gasket provided on one of the mold shells.

3. The apparatus of claim 2, further comprising a groove formed in a corresponding surface of another of the mold shells to receive the gasket.

4. The apparatus of claim 1, further comprising vents provided in at least one of the mold shells, the vents communicating with the cavity and with the exterior of the mold shells.

5. The apparatus of claim 1, wherein the mold shells have first and second ends, the first and second ends of respective mold shells being arranged adjacent each other.

6. The apparatus of claim 5, wherein the first ends of the mold shells define an opening to the exterior of the mold and in communication with the cavity to receive a preform.

7. The apparatus of claim 6, wherein the barrier is arranged in the gap to the side of the opening.

8. A blow mold, comprising:
a first mold shell having an interior surface defining a partial mold cavity and a border surface on the interior surface outside of the cavity;
a second mold shell having an interior surface defining a partial mold cavity and a border surface on the interior surface outside of the cavity, the first and second mold shells forming a mold cavity and defining an opening at a first end of the mold shells for receiving a perform into the cavity when their respective partial mold cavities and the border surfaces are arranged opposite and interface with each other;
a gap at the interface between the border surfaces of first and second mold shells adjacent to the opening at the first end; and
a barrier formed in the gap to form a seal at least partially preventing air flow through the gap into the mold cavity.

9. The mold of claim 8, wherein the barrier extends along substantially all of the gap.

10. The mold of claim 8, wherein the first mold shell was a first end and a second end
and the barrier comprises a seal arranged on the interior surface at the first end of the first mold shell, outside of the partial mold cavity.

11. The mold of claim 10, wherein the second mold shell has a first end and a second end, the first and second mold shells being arranged opposite with their respective first and second ends adjacent each other such that an opening for receiving a preform into the mold cavity is formed at the first end, the barrier being received on a corresponding surface on the second mold shell.

12. A mold comprising two mold halves defining a mold cavity therein, the mold having a first end with an opening formed by the mold halves communicating with the mold cavity and adapted to receive a preform, a parting line between the mold halves at the first end, a seal arranged in the parting line.

13. The mold of claim 12 wherein the seal extends in at least two directions from the opening.

14. A method of molding a container, comprising:
bringing a plurality of mold shells together to define a cavity corresponding to the container therein;
inserting a preform into the cavity;
blowing air into the preform in order to expand the preform within the cavity; and
substantially preventing the blow air from entering the cavity via a gap between the mold shells adjacent to where the preform is inserted.

15. The method of claim 14, wherein the preventing step comprises forming a seal between the mold shells.

16. The method of claim 14, wherein the preventing step comprises pressing a gasket between the mold shells.

17. The method of claim 14, wherein the preventing step comprises pressing a seal on at least one of the mold shells onto a corresponding surface on another of the at least one mold shells.
